(19) United States
(12) Patent Application Publication
(10) Pub. No.: US 2013/0319003 A1
(43) Pub. Date: Dec. 5, 2013

(54) AUXILIARY POWER UNIT MOUNT WITH FIRE RESISTANT SHIELDING

(71) Applicants: Jason Peel, Encinitas, CA (US); Jack V. Vitale, San Diego, CA (US); Greg R. Giddings, San Marcos, CA (US)

(72) Inventors: Jason Peel, Encinitas, CA (US); Jack V. Vitale, San Diego, CA (US); Greg R. Giddings, San Marcos, CA (US)

(21) Appl. No.: 13/483,466

(22) Filed: May 30, 2012

(51) Int. Cl. B64D 41/00

(52) U.S. Cl. 60/802

(57) ABSTRACT

An auxiliary power unit has a gas turbine engine, a generator, and a gear box. A mount bracket is mechanically attached to the gear box. The bracket is for connecting to a plurality of struts. The struts are for connecting to an aircraft housing. A shield box is formed of a flame resistant rigid material. The shield box encloses the mount bracket to provide flame protection to the mechanical attachment.

### BACKGROUND OF THE INVENTION

This application relates to a method and apparatus for providing a fire resistant shielding to a mount for mounting an auxiliary power unit (“APU”) in an aircraft.

APUs are provided in an aircraft, and are utilized as a source of power before the main gas turbine engines are started. An APU includes a gas turbine engine, a generator, and associated systems. The APU is typically mounted in a portion of an aircraft, such as the tail cone, which may be subject to any number of environmental challenges. As an example, there is potential for exposure to flame, and for mechanical stresses.

The APUs have typically been mounted by a plurality of struts attached to brackets at opposed sides of the APU. These struts are mounted to a first structural link that is in turn attached to a mount bracket that is bolted to a gear box of the APU.

It has been challenging to provide a connection between the struts and the gear box that can survive exposure to flame, and withstand the stresses encountered by the mount.

Various flame resistant blankets have been provided in an attempt to protect the connection of the bracket to the gear box. These blankets have been relatively flexible and made of composite materials. However, they are complex, costly, weigh an undesirably large amount, are relatively fragile, and require customer installation as the attachments used have often resulted in separation.

### SUMMARY OF THE INVENTION

An auxiliary power unit has a gas turbine engine, a generator, and a gear box. A mount bracket is mechanically attached to the gear box. The bracket is for connecting to a plurality of struts. The struts are for connecting to an aircraft housing. A shield box is formed of a flame resistant rigid material. The shield box encloses the mount bracket to provide flame protection to the mechanical attachment.

These and other features may be best understood from the following drawings and specification.

### BRIEF DESCRIPTION OF THE DRAWINGS

FIG. 1A schematically shows an aircraft structure including an auxiliary power unit.

FIG. 1B shows a detail of existing auxiliary power unit mounts.

FIG. 2 shows a first embodiment.

FIG. 3 shows a second embodiment.

### DETAILED DESCRIPTION

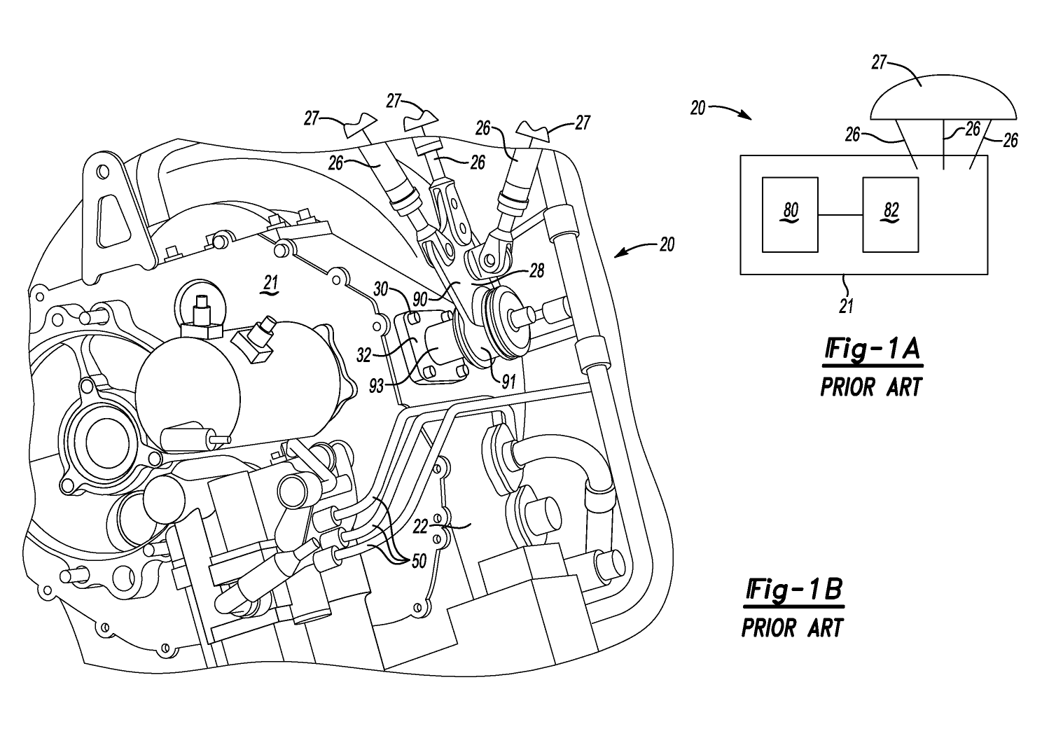

FIG. 1A shows a system 20 which includes an auxiliary power unit 21 attached through struts 26 to an aircraft housing 27. The auxiliary power unit 21 is shown to include a gas turbine engine 80 and a generator 82.

FIG. 1B shows a prior art system 20. System 20 incorporates an APU 21, shown only from the outside. It should be understood that within the APU 21 is the gas turbine engine, and an electric generator, along with all associated systems.

As shown, a gear box 22 receives a mount link 28 which is bolted (30) by a mount bracket 32 to the gear box 22. This attachment secures a plurality of struts 26 which extend to an aircraft housing 27, shown schematically. The struts 26 are attached to the mount link 28 at an area 90 spaced from a point 91 where the link 28 is secured to the bracket 32. As can be seen, a pin 93 extends from bracket 32 to the point 91. As mentioned above, there is potential for the mount bracket 32 to be exposed to flame. The mount must also withstand the mechanical stresses and strains encountered to support the APU 21 on the aircraft housing 27.

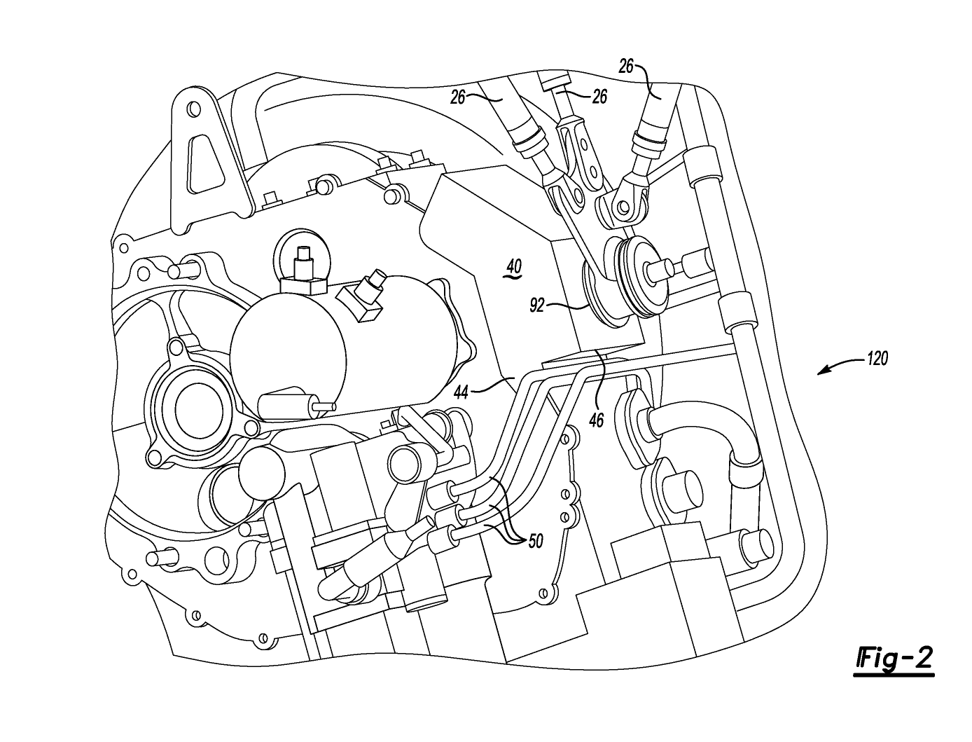

FIG. 2 shows an embodiment 120 wherein a shielding box 40 is bolted, or otherwise mechanically connected, at flange 44 to the gear box 22. Fuel lines 50 extend beneath a covering ledge 46, and provide fuel such as to the gas turbine engine within the APU 120.

In this embodiment, the struts 26 and the mount link 28 are outward of the shielding box 40. As can be seen, a hole 92 in shielding' box 40 allows the pin 93 to extend outwardly. The shielding box 40 protects the underlying mount bracket 32 and its bolts 30.

Also, the shielding box 50 covers and protects a portion of the gearbox 22 near the mount brackets 32. In a fire situation, the gearbox may be engulfed and transfer fire to the mount bracket 32. The shielding box limits this heat transfer by covering the gearbox 22 near the bracket 32.

The fuel lines 50 can be seen to be received in an open space between the ledge 46 and the flange 44.

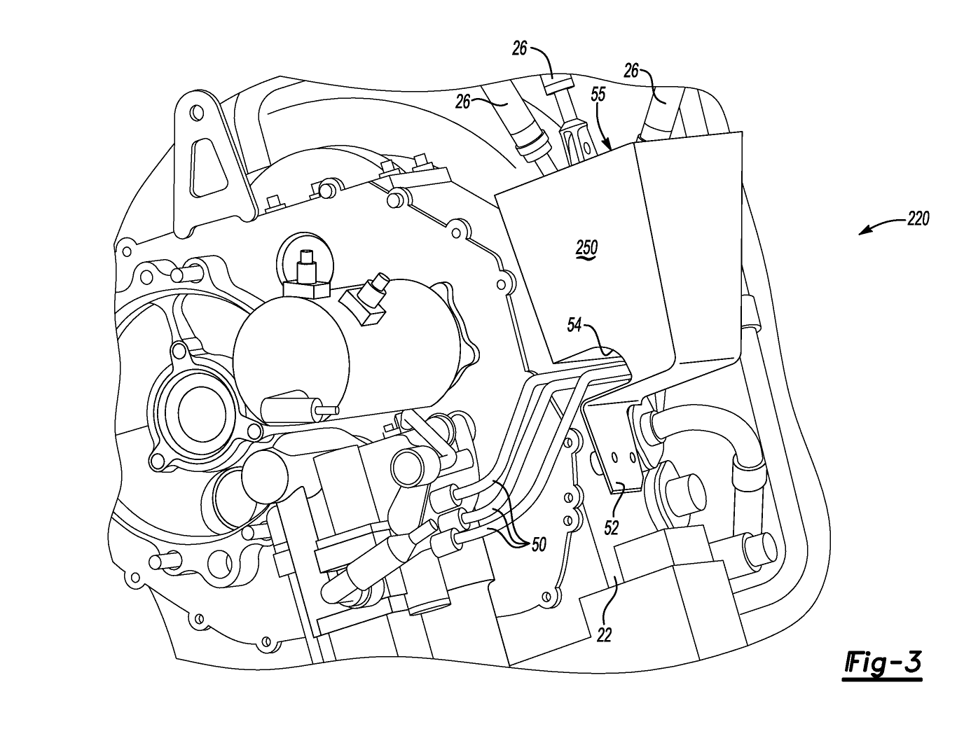

FIG. 3 shows another embodiment 220 wherein a shielding box 250 incorporates a lower plate 52 that is bolted to the gear box 22. In embodiment 220, the fuel lines 50 extend through a notch 54. It should be understood a corresponding notch 54 is on the opposed side of the shielding box 250.

In addition, the struts 26, and the underlying mount link 28 (not seen in FIG. 3) are all enclosed within the shielding box 250. That is, area 90 is within the enclosure. An upper surface 55 of the shield 50 may be open to allow the struts 26 to extend outwardly.

The shielding boxes are formed of flame resistant rigid material. An appropriate metal, or a fiber composite material may be utilized to form the shielding boxes. Suitable metals may include a stainless steel, Inconel, or titanium, or various alloys of those metals. Potential composite materials may include carbon or fiberglass materials.

Although embodiments of this invention have been disclosed, a worker of ordinary skill in this art would recognize that certain modifications would come within the scope of this invention. For that reason, the following claims should be studied to determine the true scope and content of this invention.

1. An auxiliary power unit comprising:
a gas turbine engine, a generator, and a gear box;
a mount bracket mechanically attached to said gear box;
said mount bracket for being connected to a plurality of struts, said struts for being connected to an aircraft housing; and
a shield box formed of a flame resistant rigid material, said shield box enclosing said mount bracket and said mechanical attachment.

2. The auxiliary power unit as set forth in claim 1, wherein said mount bracket is connected to a mount link, said mount link for being connected to said struts.

3. The auxiliary power unit as set forth in claim 2, wherein said mount link being outwardly of said shield box and said mount bracket being received inwardly of said shield box.

4. The auxiliary power unit as set forth in claim 3, wherein fuel lines extend to supply fuel to the gas turbine engine, and said fuel lines being positioned outwardly of said shield box.

5. The auxiliary power unit as set forth in claim 4, wherein said shield box has a downwardly extending flange which is mechanically connected to said gear box, and a ledge extending away from said gear box, with said fuel lines extending in a space between said flange and said ledge.

6. The auxiliary power unit as set forth in claim 2, wherein said shield box enclosing said mount brackets and said mount link, and an attachment location on said mount bracket for receiving the struts also being within said shield box.

7. The auxiliary power unit as set forth in claim 6, wherein fuel lines extend to supply fuel to the gas turbine engine, and said fuel lines extending through a slot in said shield box.

8. The auxiliary power unit as set forth in claim 7, wherein said shield box has an open top surface such that the struts can extend outwardly of the open top surface once attached.

9. The auxiliary power unit as set forth in claim 2, wherein fuel lines extend to supply fuel to the gas turbine engine, and said fuel lines extending through a slot in said shield box.

10. The auxiliary power unit as set forth in claim 1, wherein said shield box is formed of metal.

11. The auxiliary power unit as set forth in claim 1, wherein said shield box is formed of a fiber composite material.

12. An aircraft including:
an aircraft housing, a plurality of struts attached to said housing;
said struts also connected to a mount plate on an auxiliary power unit, the auxiliary power unit including a gas turbine engine, a generator, and a gear box;
said mount bracket mechanically attached to said gear box;
a shield box formed of a flame resistant rigid material, said shield box enclosing said mount bracket and said mechanical attachment.

13. The aircraft as set forth in claim 12, wherein said mount bracket is connected to a mount link, said mount link for being connected to said struts.

14. The aircraft as set forth in claim 13, wherein said mount link being outwardly of said shield box and said mount bracket being received inwardly of said shield box.

15. The aircraft as set forth in claim 14, wherein fuel lines extend to supply fuel to the gas turbine engine, and said fuel lines being positioned outwardly of said shield box.

16. The aircraft as set forth in claim 15, wherein said shield box has a downwardly extending flange which is mechanically connected to said gear box, and a ledge extending away from said gear box, with said fuel lines extending in a space between said flange and said ledge.

17. The aircraft as set forth in claim 13, wherein said shield box enclosing said mount brackets and said mount link, and an attachment location on said mount bracket for receiving the struts also being within said shield box.

18. The aircraft as set forth in claim 17, wherein fuel lines extend to supply fuel to the gas turbine engine, and said fuel lines extending through a slot in said shield box.

19. The aircraft as set forth in claim 12, wherein said shield box is formed of metal.

20. The aircraft as set forth in claim 12, wherein said shield box is formed of a fiber composite material.
